(19) United States
(12) Patent Application Publication
(10) Pub. No.: US 2025/0216232 A1
(43) Pub. Date: Jul. 3, 2025

(54) ELECTROMAGNETIC FLOWMETER AND METHOD FOR MANUFACTURING THE SAME

(71) Applicant: ABB SCHWEIZ AG, Baden (CH)

(72) Inventor: Jianjun Wu, Ningbo (CN)

(21) Appl. No.: 19/085,469

(22) Filed: Mar. 20, 2025

Related U.S. Application Data
(63) Continuation of application No. PCT/CN2022/120892, filed on Sep. 23, 2022.

(51) Int. Cl. G01F 1/58; C09J 5/06; C09J 9/02; C09J 163/00

(52) U.S. Cl. CPC G01F 1/586; C09J 5/06; C09J 9/02; C09J 163/00; G01F 1/584

(57) ABSTRACT

Embodiments of the present disclosure provide an electromagnetic flowmeter including a measurement tube through which a fluid to be measured flows. Magnet coils are arranged outside the measurement tube and used for generating a magnetic field. Electrodes are provided on the measurement tube and used for measuring a voltage of the fluid induced in the magnetic field Each electrode is coated with a protection layer. Embodiments of the present disclosure provide a method for applying a protection layer to the electromagnetic flowmeter.

### FIELD

Embodiments of the present disclosure generally relate to an electromagnetic flowmeter used to monitor fluid flow. Embodiments of the present disclosure also relate to a method for manufacturing the electromagnetic flowmeter.

### BACKGROUND

An electromagnetic flowmeter (EMF) is a device used for flow rate measurement of a fluid, which is widely used in different industries.

A voltage is generated in a conductor when it moves through a magnetic field. This principle can be applied to a conductive fluid. In particular, the voltage induced in the conductive fluid can be measured by an electrode arrangement of an electromagnetic flowmeter. The electrode arrangement includes electrodes provided in a measurement tube of the electromagnetic flowmeter.

However, during the use of an electromagnetic flowmeter, an oxidational layer may be generated on a surface of an electrode of the electromagnetic flowmeter. In a situation that solid particles are carried in a flow of a fluid (for example, the fluid is slurry), the solid particles may scrape the oxidational layer and introduce a large noise into a raw signal. In order to lower such noise, one method is to make electrodes smaller and to polish the electrodes for decreasing the surface roughness of the electrodes. However, this way may increase the internal resistance at the same time, which is undesired for low conductivity flow measurement. Another way is to raise a driving frequency since the noise amplitude is decreasing along with the frequency increasing. However, this way may make zero point unsteady.

Hence, there is a need to propose an electromagnetic flowmeter that overcomes the above disadvantages in the art.

### SUMMARY

In order to overcome the disadvantages in the prior art, the present application proposes an electromagnetic flowmeter, in which a non-metal layer is applied on the electrode surface of the electrodes of the electromagnetic flowmeter. The electrodes of the electromagnetic flowmeter, with added non-metal layers, have good conductivity for measurement while not increasing the internal resistance too much. Further, it is strong enough to protect the electrode surface, which provides a stable raw signal during the grout measurement.

Embodiments of the present disclosure provide an electromagnetic flowmeter, and associated manufacturing method.

In a first aspect of the present disclosure, an electromagnetic flowmeter, comprising: a measurement tube, through which a fluid to be measured flows; magnet coils arranged outside the measurement tube and used for generating a magnetic field; and electrodes provided on the measurement tube and used for measuring a voltage of the fluid induced in the magnetic field, wherein each electrode is coated with a protection layer. With the feature, the electrodes of the electromagnetic flowmeter have good conductivity for measurement while not increasing the internal resistance too much and the protection layer is strong enough to protect the electrode surface, which provides a stable raw signal during the grout measurement.

In some embodiments, a pair of magnet coils are arranged diametrically opposite to each other. With the feature, a magnetic field can be generated.

In some embodiments, the electrodes are arranged diametrically opposite to each other. With the feature, a voltage can be generated when the fluid moves through the magnetic field.

In some embodiments, a liner is provided inside the measurement tube and the liner is made of electrical insulation material. With the feature, the measurement tube is insulated from the fluid.

In some embodiments, the measurement tube has a through hole and the liner has a through hole, in which the through hole of the measurement tube and the through hole of the liner are concentric and the diameter of the through hole of the measurement tube is larger than the diameter of the through hole of the liner. With the feature, the electrode can be inserted and fixed.

In some embodiments, each electrode has a head, in which the head of each electrode is coated with the protection layer. With the feature, the electrodes of the electromagnetic flowmeter have good conductivity for measurement while not increasing the internal resistance too much and the protection layer is strong enough to protect the electrode surface, which provides a stable raw signal during the grout measurement.

In some embodiments, each electrode has a body, in which the body of the electrode successively extends through the through hole of the measurement tube and the through hole of the liner. With the feature, the electrode can be inserted and fixed.

In some embodiments, an insulation bush is provided at the through hole of measurement tube, in which the insulation bush is provided with a boss at a lower end and the boss is pressed against the through hole of the measurement tube. With the feature, the measurement tube can be insulated from the parts outside the measurement tube.

In some embodiments, the insulation bush has a through hole which comprises a plurality of sections, a section near the boss is pressed against the body of the electrode, and other sections far from the boss have a larger internal diameter than that of the section near the boss for easy installation. With the feature, the electrode can be inserted and fixed.

In some embodiments, a wire soldered pin is provided on the top surface at an upper end of the insulation bush, in which a wire is soldered to the wire soldered pin to transmit signals from the electrode. With the feature, signals can be transmitted for measurement.

In some embodiments, a flat washer is provided upon the wire soldered pin, and on the top surface of the flat washer, a spring washer is provided. With the feature, these parts can be installed properly.

In some embodiments, a nut has internal threads and the internal threads are engaged with external threads of the body of the electrode, and the flat washer and the spring washer are positioned between the nut and the wire soldered pin for fixing the electrode. With the feature, these parts can be fixed properly and the electrode can be inserted and fixed.

In some embodiments, the fluid is a conductive fluid that contains particles. With the feature, Faraday's law of induction can be applied to the conductive fluid.

In a second aspect of the present disclosure, a method for applying a protection layer to the electromagnetic flowmeter is provided, comprising: a conductive adhesive and an epoxy glue being mixed together; the electrodes of the electromagnetic flowmeter being immersed into a mixture of the conductive adhesive and the epoxy glue; and after a predetermined period of time, the electrodes being taken out of the mixture to put steadily for solidification. With the feature, the protection layer can be applied to the electromagnetic flowmeter, which makes the electrodes of the electromagnetic flowmeter good conductivity for measurement while not increasing the internal resistance too much and the protection layer is strong enough to protect the electrode surface, which provides a stable raw signal during the grout measurement.

In a third aspect of the present disclosure, a method for applying a protection layer to the electromagnetic flowmeter is provided, comprising: a conductive adhesive being applied to the electrodes of the electromagnetic flowmeter; the electrodes with the conductive adhesive being heated at a first predetermined temperature for a first predetermined period of time; and the electrodes with the conductive adhesive being heated at a second predetermined temperature for a second predetermined period of time. With the feature, the protection layer can be applied to the electromagnetic flowmeter, which makes the electrodes of the electromagnetic flowmeter good conductivity for measurement while not increasing the internal resistance too much and the protection layer is strong enough to protect the electrode surface, which provides a stable raw signal during the grout measurement.

In some embodiments, the electrodes with the conductive adhesive are heated at 100° C. for 30 minutes, and then the electrodes with the conductive adhesive are heated at 200° C. for 2 hours. With the feature, the protection layer is formed after the high temperature becomes a lower temperature and the conductive adhesive has the characteristics of conductivity, strong adhesion and firmness, and no additional adhesive is required.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent the same components.

FIG. 1 is a schematic diagram of an electromagnetic flowmeter in an X-Y-Z coordinate system according to embodiments of the present disclosure;

FIG. 2 is a schematic diagram of an electromagnetic flowmeter according to embodiments of the present disclosure;

FIG. 3 is a sectional view of an electromagnetic flowmeter according to embodiments of the present disclosure;

FIG. 4 is a partial enlarged sectional view of an electromagnetic flowmeter according to embodiments of the present disclosure;

FIG. 5 is a sectional view of an electrode of an electromagnetic flowmeter according to embodiments of the present disclosure; and

FIG. 6 is a sectional view of an electrode without protection layer; and

FIG. 7 is a sectional view of an electrode with protection layer according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

Measurement performed by an electromagnetic flowmeter is based on Faraday's law of induction. A voltage is generated in a conductor when it moves through a magnetic field. This principle is applied to a conductive fluid in a measuring tube through which a magnetic field is generated perpendicular to the flow direction. The voltage induced in the fluid is measured by for example two electrodes located diametrically opposite to each other. The voltage is proportional to the magnetic induction, the electrode spacing and the average flow velocity. Considering that the magnetic induction and the electrode spacing are constant values, proportionality exists between the voltage and the average flow velocity. That is, the voltage is linearly proportional to the volume flow rate. The induced voltage is converted by a transmitter to a standardized, analog and digital signal to indicate the flow rate. Since the measured voltage obtained in this way is proportional to the average flow rate of the flowing fluid, the volume flow rate of the fluid can be obtained from this. The mass flow rate of the fluid can be determined by taking into account the density of the flowing fluid.

In particular, FIG. 1 is a schematic diagram of an electromagnetic flowmeter in an X-Y-Z coordinate system. The electromagnetic flowmeter 1 comprises electrodes 10, a measurement tube 20 and magnet coils 30. In an embodiment, a pair of magnet coils 30 are preferably arranged diametrically opposite to each other. In an embodiment, there are two magnet coils 30 that are arranged in the vertical direction, in which one of the magnet coils 30 is arranged above the measurement tube 20 and the other one of the magnet coils 30 is arranged below the measurement tube 20, as shown in FIG. 1. In the embodiment of FIG. 1, the magnet coils 30 are used for generating a magnetic field in the vertical direction. In other embodiments, the magnet coils 30 can be arranged in other directions.

According to Faraday's law of induction, a voltage is generated in a conductor when it moves through a magnetic field. In the embodiment of FIG. 1, the fluid flowing through the measurement tube 20 may be a conductive fluid. The fluid may be slurry or other fluids that may contain particles. The fluid may flow in a direction along a longitudinal direction, for example, along a direction of the Z-axis, or along a direction opposite to the Z-axis, as shown in FIG. 1. The magnetic field generated by the magnet coils 30 is oriented substantially perpendicular to the flow direction of the fluid, for example, along a direction of the Y-axis, or along a direction opposite to the Y-axis, as shown in FIG. 1. The fluid, as a conductor, flows in the flow direction moving through the magnetic field, so that a voltage U is induced through the fluid flowing in the magnetic field. At least two electrodes 10 (for example, a pair of electrodes) are inserted opposite one another on the wall of the measurement tube 20. The electrodes 10 are used for detecting the voltage U which is induced through the flowing fluid in the magnetic field. In particular, each of the electrodes 10 comes into contact with the flowing fluid by means of at least one end face, so that the electrodes operate in the manner of galvanic electrodes.

FIG. 1 shows two electrodes 10 that are preferably arranged diametrically opposite to each other. Preferably, the electrodes 10 are located in a horizontal plane. The induced voltage in the fluid to be measured by the electrodes is proportional to the magnetic induction, the electrode spacing and the average flow velocity v. The electrode spacing can be the same as the diameter D of the measurement tube 20. In view of the fact that the magnetic induction and the electrode spacing are constant values, proportionality exists between the voltage U and the average flow velocity v. That is, the voltage U is linearly proportional to the volume flow rate. Since the voltage obtained in this way is proportional to the average flow rate v of the flowing fluid, the volume flow rate of the fluid can be obtained from the voltage U. In another embodiment, the mass flow rate of the fluid can also be determined by taking into account the density of the flowing fluid.

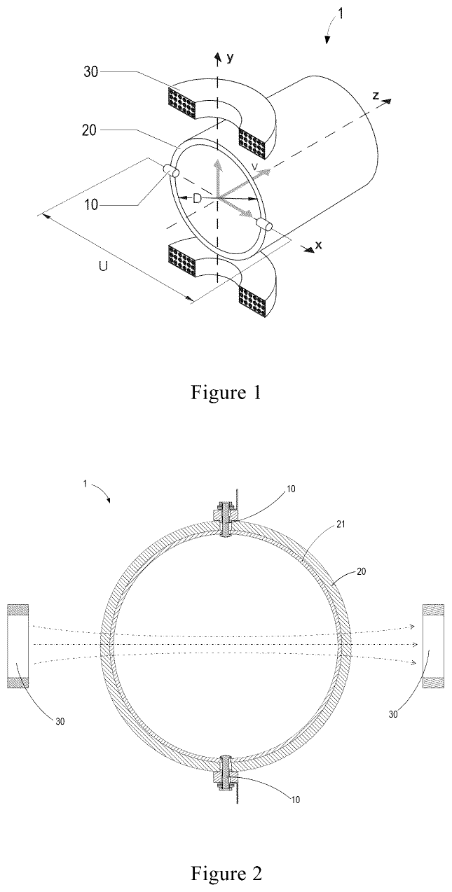

FIG. 2 is a schematic diagram of an electromagnetic flowmeter. In the embodiment of FIG. 2, the pair of electrodes 10 are preferably arranged diametrically opposite to each other in the vertical direction. In the illustrated embodiment, the pair of magnet coils 30 are preferably arranged diametrically opposite to each other in a horizontal plane.

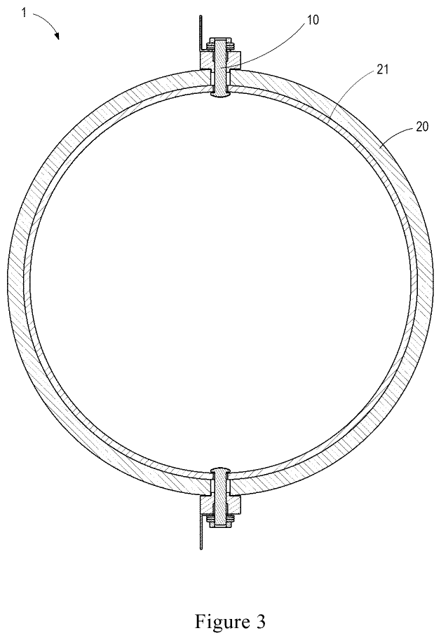

FIG. 3 shows a sectional view of an electromagnetic flowmeter. A liner 21 is provided inside the measurement tube 20. The liner 21 may be made of electrical insulation material, preferably plastic material. The liner 21 is close fit to the measurement tube 20 and is used to insulate the measurement tube 20 from the flowing fluid. The electrodes 10 are fixed on the wall of the measurement tube 20 to measure the voltage and the measurement data can be transmitted from the electrodes to a processing unit or a control unit. The processing unit or the control unit can determine the flow rate of the fluid based on the measurement data of the voltage.

As shown in FIG. 3, there are two electrodes 10 diametrically opposite to each other. In other embodiments, more than two electrodes 10 are provided. In other embodiments, these electrodes may not be diametrically opposite to each other.

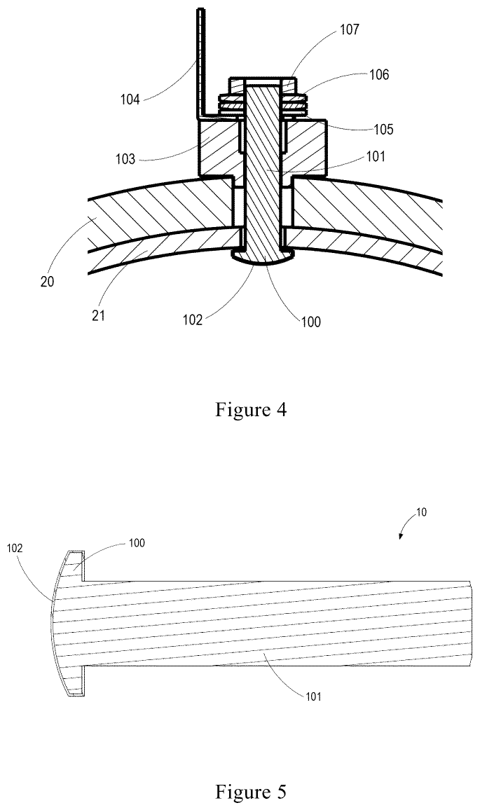

FIG. 4 is a partial enlarged sectional view of an electromagnetic flowmeter. As shown in FIG. 4, there is a through hole on the wall of the measurement tube 20. There is also a through hole of the liner 21. The through hole of the measurement tube 20 and the through hole of the liner 21 are concentric. In an embodiment, the diameter of the through hole of the measurement tube 20 is larger than the diameter of the through hole of the liner 21.

FIG. 5 shows a sectional view of an electrode of an electromagnetic flowmeter. As shown in FIG. 5, an electrode 10 may have a head 100 and a body 101, and the body 101 of the electrode 10 successively extends through the through hole of the measurement tube 20 and the through hole of the liner 21.

Referring back to FIG. 5, an insulation bush 103 is provided at the through hole of measurement tube 20. The insulation bush 103 is provided with a boss at a lower end and the boss is pressed against the through hole of the measurement tube 20. The insulation bush 103 has a through hole which may comprise a plurality of sections. The section near the boss is pressed against the body of the electrode, in order to fix the electrode in place. Other sections far from the boss may have a larger internal diameter than that of the section near the boss for easy installation. The body of the electrode extends through hole of the insulation bush 103 too.

A wire soldered pin 104 is provided on the top surface at an upper end of the insulation bush 103. A wire is soldered to the wire soldered pin 104 to transmit signals from the electrode to the processing unit or the control unit. The signals can be converted to standardized, analog and digital signals to indicate the flow rate. The wire soldered pin 104 may have a flat portion which has a through hole through which the electrode extends.

A flat washer 105 is provided upon the wire soldered pin 104. In an embodiment, the flat washer 105 is provided on the flat portion of the wire soldered pin 104. On the top surface of the flat washer 105, a spring washer 106 is provided. The spring washer 106 may be in a form of coil spring. The body of the electrode or a part of the body of the electrode may have external threads. A nut 107 has internal threads and the internal threads can be engaged with the external threads of the body of the electrode. The flat washer 105 and spring washer 106 are positioned between the nut 107 and the wire soldered pin 104, which contributes to fixing the electrode.

Referring to FIGS. 4 and 5, a non-metal layer 102 is coated on the surface of the head 100 of the electrode 10. When the electrode contacts the fluid to be measured, which is for example electrolyte, passivation reaction occurs and there is an oxidational layer generating on the electrode surface to protect the electrode from corrosion. The layer thickness is very small which is almost in nanoscale. If there are solid particles like sand and plastic particles in the fluid, they may hit and scratch the electrode surface, breaking the oxidational layer and making large sharp noise into the raw measurement signal. The oxidational layer may recover and be destroyed constantly, and the related noise always exists during the measurement. In other words, without the non-metal layer, the oxidational layer may be generated on the surface of the electrode during use. And in a situation that solid particles are carried in a flow of the fluid (for example the fluid is slurry), the solid particles may scrape the oxidational layer and introduce a large noise into the raw signal. In order to avoid this undesired situation, the present application adds a non-metal layer on the surface of the head of the electrode. With the coated non-metal layer, the electrode will has good conductivity for measurement while not increasing the internal resistance too much, and the non-metal layer is strong enough to protect the electrode surface, which provides a stable raw signal during the grout measurement.

As shown in FIG. 5, a non-metal layer 102 is applied to a head 100 of an electrode 10. The non-metal layer 102 is used as a protection layer on the electrode surface. It is conductive to guarantee the electrode's normal work. The protection layer can prevent the electrode from passivation and corrosion. Further, the protection layer is made of non-metal material, so that there is no oxidational reaction.

The protection layer may be made of conductive adhesive and epoxy glue. The conductive adhesive has very good conductivity but its adhesive ability may not be good. Thus, the conductive adhesive can be mixed with epoxy glue whose adhesive ability is better. In an embodiment, the conductive adhesive is made of epoxy glue, conductive particles and additive. The conductive particles may be one of gold powder, silver powder and graphite powder.

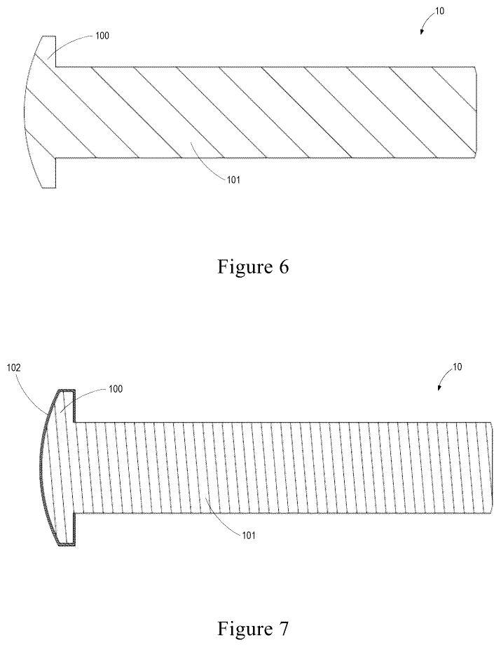

In an embodiment, the conductive adhesive and the epoxy glue are mixed together. Then, the head of the electrode is immersed into a mixture of the conductive adhesive and the epoxy glue. After a predetermined period of time, the electrode is taken out of the mixture. The electrode is then put steadily for solidification. A protection layer is formed from the mixture after solidification. FIG. 6 shows a sectional view of an electrode without protection layer. For example, the electrode in FIG. 6 is in a situation before being immersed into the mixture. FIG. 7 shows a sectional view of an electrode with protection layer. For example, the electrode in FIG. 7 is in a situation after the protection layer is formed.

In some example embodiments, rising the ambient temperature can speed up this process. After the solidification procedure, there will be a strong protection layer formed on the electrode surface. In an embodiment, the conductive adhesive can be directly applied to the electrode surface without any additional adhesive. That is, a conductive adhesive is applied to the head of the electrode. For example, the conductive adhesive contains sliver powder. The head of the electrode with the conductive adhesive is heated at a first predetermined temperature for a first predetermined period of time firstly. For example, the head of the electrode with the conductive adhesive is heated at 100° C. for 30 minutes. Then, the head of the electrode with the conductive adhesive is then heated at a second predetermined temperature for a second predetermined period of time. For example, the head of the electrode with the conductive adhesive is then heated at 200° C. for 2 hours. A protection layer is solidified and formed after the high temperature turns to a lower temperature. In this example, the conductive adhesive has the characteristics of conductivity, strong adhesion and firmness, and no additional adhesive is required.

After forming the protection layer, the electrode resistance needs to be check. If the resistance of the electrode with the protection layer is too much larger than the electrode without protection layer, the protection layer can be made thinner. However, the protection layer shall not be too thin to be destroyed easily. After that, the electrode with the protection layer can be installed into the electromagnetic flowmeter. In an embodiment, an oxidational layer at the electrode surface can be covered with a protection layer, so that the electromagnetic flowmeter can provide steady and strong signals during the application for flowing fluid with solids.

In the embodiments as shown in FIG. 4-6, the head 100 of the electrode 10 has a convex-shape, for example, a spherical-shape. In a variant, the head of the electrode has a concave shape, which can reduce the effect of the lash from the flowing fluid.

Please note that the above description regarding the electrode is only refers to only one electrode. An electromagnetic flowmeter may have a plurality of electrodes and those electrodes may have the same structure as the described one. That is, the above description 5 about one electrode can be also applied to other electrodes.

It should be appreciated that the above detailed embodiments of the present disclosure are only for exemplifying or explaining principles of the present disclosure and do not limit the present disclosure. Therefore, any modifications, equivalent alternatives and improvements, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. An electromagnetic flowmeter, comprising:
a measurement tube through which a fluid to be measured flows;
a pair of magnet coils arranged outside the measurement tube and configured to generate a magnetic field; and
at least one pair of electrodes provided on the measurement tube and configured to measure a voltage of the fluid induced in the magnetic field,
wherein each electrode is coated with a protection layer.

2. The electromagnetic flowmeter of claim 1, wherein the pair of magnet coils are arranged diametrically opposite to each other.

3. The electromagnetic flowmeter of claim 1, wherein each pair of electrodes are arranged diametrically opposite to each other.

4. The electromagnetic flowmeter of claim 1, further comprising a liner provided inside the measurement tube and made of electrical insulation material.

5. The electromagnetic flowmeter of claim 4, wherein a circumferential wall of the measurement tube comprises a first through hole;
the liner comprises a second through hole; and
the first through hole of the measurement tube and the second through hole of the liner are concentric and a diameter of the first through hole of the measurement tube is greater than the diameter of the second through hole of the liner.

6. The electromagnetic flowmeter of claim 1, wherein each electrode comprises a head, the head of each electrode being coated with the protection layer.

7. The electromagnetic flowmeter of claim 5, wherein each electrode comprises a body, the body of each electrode successively extending through the first through hole of the measurement tube and the second through hole of the liner.

8. The electromagnetic flowmeter of claim 7, wherein an insulation bush is provided at the first through hole of the measurement tube; and
the insulation bush is provided with a boss at a lower end, and the boss is pressed against the first through hole of the measurement tube.

9. The electromagnetic flowmeter of claim 8, wherein the insulation bush has a through hole comprising a plurality of sections, a section of the plurality of sections near the boss is pressed against the body of each electrode, and other sections of the plurality of sections far from the boss have a larger internal diameter than that of the section of the plurality of sections near the boss.

10. The electromagnetic flowmeter of claim 9, wherein a wire soldered pin is provided on a top surface at an upper end of the insulation bush, in which a wire is soldered to the wire soldered pin to transmit signals from each electrode.

11. The electromagnetic flowmeter of claim 10, wherein a flat washer is provided upon the wire soldered pin, and a spring washer is provided on the top surface of the flat washer.

12. The electromagnetic flowmeter of claim 11, wherein each electrode comprises a nut having internal threads and the internal threads are engaged with external threads of the body of each electrode, and the flat washer and the spring washer are positioned between the nut and the wire soldered pin for fixing each electrode.

13. The electromagnetic flowmeter of claim 1, wherein the fluid is a conductive fluid that contains particles.

14. A method for applying a protection layer to the electromagnetic flowmeter of claim 1, comprising:
mixing a conductive adhesive and an epoxy glue being together;
immersing the electrodes of the electromagnetic flowmeter into a mixture of the conductive adhesive and the epoxy glue; and
taking the electrodes out of the mixture to put steadily for solidification after a predetermined period of time.

15. A method for applying a protection layer to the electromagnetic flowmeter of claim 1, comprising:
applying a conductive adhesive to the electrodes of the electromagnetic flowmeter;
locating the electrodes with the conductive adhesive at a first predetermined temperature for a first predetermined period of time; and
heating the electrodes with the conductive adhesive at a second predetermined temperature for a second predetermined period of time.

16. The method of claim 15, wherein the electrodes with the conductive adhesive are heated at 100° C. for 30 minutes, and then the electrodes with the conductive adhesive are heated at 200° C. for 2 hours.

17. The electromagnetic flowmeter of claim 3, wherein the fluid is a conductive fluid that contains particles.

18. The electromagnetic flowmeter of claim 6, wherein the fluid is a conductive fluid that contains particles.

19. The electromagnetic flowmeter of claim 9, wherein the fluid is a conductive fluid that contains particles.

20. The electromagnetic flowmeter of claim 12, wherein the fluid is a conductive fluid that contains particles.
